(19) United States
(12) Patent Application Publication
(10) Pub. No.: US 2026/0150788 A1
(43) Pub. Date: Jun. 4, 2026

(54) BALE WRAP AND BALE IDENTIFICATION SYSTEM OF AN AGRICULTURAL HARVESTER

(71) Applicants: CNH Industrial Canada, Ltd., Saskatoon (CA); CNH Industrial America LLC, New Holland, PA (US)

(72) Inventors: Martin J. Roberge, Quebec (CA); Steven Alexander Iseman, Akron, PA (US); Cale Boriack, Lititz, PA (US); Pooya Naderi, Quebec (CA); Jordan Beckhusen, McGregor, TX (US)

(21) Appl. No.: 19/408,938

(22) Filed: Dec. 4, 2025

Related U.S. Application Data
(60) Provisional application No. 63/727,807, filed on Dec. 4, 2024.

(51) Int. Cl. A01F 15/07; G09F 3/02

(52) U.S. Cl. CPC A01F 15/071; G09F 3/02; A01F 2015/0745; A01F 2015/076

(57) ABSTRACT

A bale wrap includes a bale wrap substrate and multiple bale identifiers disposed on or within the bale wrap substrate. The bale identifiers are arranged in multiple patterns, each pattern is formed by a set of two or more bale identifiers, each pattern extends along a length of the bale wrap equal to a minimum bale circumference, and the patterns do not overlap one another along the length of the bale wrap. Furthermore, each pattern is different than an adjacent pattern, such that each bale identifier of the set of bale identifiers of the pattern does not overlap any bale identifier of the set of bale identifiers of the adjacent pattern while a section of the bale wrap having the pattern and the adjacent pattern is wrapped around a bale having the minimum bale circumference.

### CROSS-REFERENCE TO RELATED APPLICATION

This application claims priority from and the benefit of U.S. Provisional Application Ser. No. 63/727,807, entitled “BALE WRAP AND BALE IDENTIFICATION SYSTEM FOR AN AGRICULTURAL HARVESTER”, filed Dec. 4, 2024, which is hereby incorporated by reference in its entirety.

### BACKGROUND

Agricultural harvesters are used to harvest agricultural products (e.g., cotton or other natural material(s)). For example, an agricultural harvester may include a header having row units configured to harvest the agricultural product from a field. The agricultural harvester may also include an air-assisted conveying system configured to move the agricultural product from the row units to an accumulator. The agricultural product may then be fed into a baler via a conveying system. By way of further example, the agricultural harvester may include a pickup mechanism configured to feed the agricultural product from the ground to the baler. The baler may compress the agricultural product into a package to facilitate storage, transport, and handling of the agricultural product. For example, a round baler may compress the agricultural product into a round bale within a baling chamber, such that the round bale has a desired size and density. After forming the bale, the bale may be wrapped with a bale wrap to secure the agricultural product within the bale and to generally maintain the shape of the bale. Numerous bales may be wrapped during this process and, as such, the bales need to be properly identified.

Accordingly, there is a need for a mechanism that enables efficient identification of the bales.

### BRIEF DESCRIPTION

In certain embodiments, a bale wrap includes a bale wrap substrate and multiple bale identifiers disposed on or within the bale wrap substrate. The bale identifiers are arranged in multiple patterns, each pattern is formed by a set of two or more bale identifiers, each pattern extends along a length of the bale wrap equal to a minimum bale circumference, and the patterns do not overlap one another along the length of the bale wrap. Furthermore, each pattern is different than an adjacent pattern, such that each bale identifier of the set of bale identifiers of the pattern does not overlap any bale identifier of the set of bale identifiers of the adjacent pattern while a section of the bale wrap having the pattern and the adjacent pattern is wrapped around a bale having the minimum bale circumference.

Furthermore, in certain embodiments, a bale identification system of an agricultural harvester includes a scanner directed to a region external to the agricultural harvester. The scanner scans a bale identifier of a bale wrap while a section of the bale wrap including the bale identifier is disposed about a bale in a field. In addition, the scanner outputs a signal indicative of a respective bale code, in which the respective bale code corresponds to the bale identifier. The bale identification system also includes a controller communicatively coupled to the scanner, in which the controller includes a processor and a memory. The controller receives the signal indicative of the respective bale code and associates the bale with the respective bale code.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a perspective view of an embodiment of an agricultural harvester having an agricultural product transport assembly and a baler.

FIG. 2 is a schematic view of an embodiment of an agricultural product transport assembly, an embodiment of a baler, and an embodiment of a bale handler system that may be employed within the agricultural harvester of FIG. 1.

FIG. 3 is a block diagram of an embodiment of a bale identification system that may be employed within the agricultural harvester of FIG. 1.

FIG. 4 is a schematic side view of an embodiment of a wrapped bale that may be identified by the bale identification system of FIG. 3.

FIG. 5 is a schematic view of an embodiment of a section of a bale wrap that may be disposed about a bale, in which the bale wrap includes bale identifiers that may be scanned by the bale identification system of FIG. 3.

FIG. 6 is a schematic view of another embodiment of a section of a bale wrap that may be disposed about a bale, in which the bale wrap includes bale identifiers that may be scanned by the bale identification system of FIG. 3.

FIG. 7 is a schematic view of a further embodiment of a section of a bale wrap that may be disposed about a bale, in which the bale wrap includes bale identifiers that may be scanned by the bale identification system of FIG. 3.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

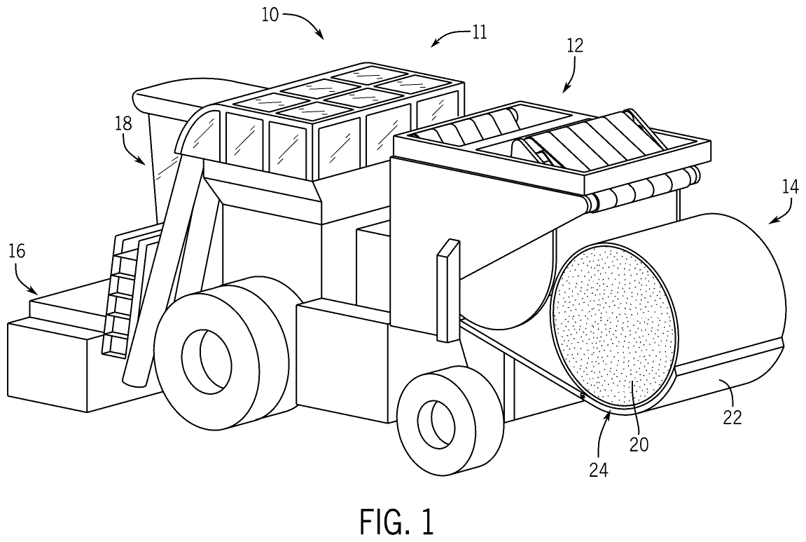

FIG. 1 is a perspective view of an embodiment of an agricultural harvester 10 (e.g., harvester, agricultural harvester) having an agricultural product transport assembly 11 and a baler 12. The agricultural harvester 10 harvests agricultural product (e.g., cotton) from a field and forms the agricultural product into bales 14 (e.g., agricultural bales). In the illustrated embodiment, the agricultural harvester 10 includes a header 16 having row units that harvest the agricultural product from the field. Additionally, the agricultural product transport assembly 11 of the agricultural harvester 10 includes an air-assisted conveying system 18 that moves the agricultural product from the row units of the header 16 to an accumulator assembly of the agricultural product transport assembly 11. The agricultural product transport assembly 11 also includes a conveying system that conveys the agricultural product from the accumulator assembly into the baler 12 (e.g., agricultural baler). The baler 12 is supported by and/or mounted within or on a chassis of the agricultural harvester 10. The baler 12 may form the agricultural product 20 into round bales 14. However, in other embodiments, the baler of the agricultural harvester may form the agricultural product into square bales, polygonal bales, or bales of other suitable shape(s). After forming the agricultural product 20 into a bale 14, a bale wrapping system of the agricultural harvester 10 wraps the bale with a section of a bale wrap to secure the agricultural product 20 within the bale 14 and to generally maintain a shape of the bale 14.

After the bale 14 is wrapped, a bale ejection system of the baler 12 ejects the bale to a bale handler 22 of a bale handler system 24. The bale handler 22 supports the bale 14 (e.g., while a subsequent bale is being formed by the baler). In addition, the bale handler system 24 discharges the bale 14 onto the surface of the field. For example, one or more actuators of the bale handler system 24 may drive the bale handler 22 downwardly to enable the bale 14 to roll onto the surface of the field. After the bale 14 is discharged, the actuator(s) of the bale handler system 24 may drive the bale handler 22 to a position for receiving the subsequent bale or to a storage (e.g., home) position.

In certain embodiments, the agricultural harvester 10 includes a bale identification system having a scanner directed to a region external to the agricultural harvester 10. The scanner scans a bale identifier of a bale wrap while a section of the bale wrap including the bale identifier is disposed about a bale in the field (e.g., after the bale has been discharged from the bale handler system 24). The scanner outputs a signal indicative of a respective bale code, and the respective bale code corresponds to the bale identifier. The bale identification system also includes a controller communicatively coupled to the scanner. The controller includes a processor and a memory, and the controller receives the signal indicative of the respective bale code and associates the bale with the respective bale code. Accordingly, the bale identification system may identify a bale in the field (e.g., after the bale is discharged from the bale handler system).

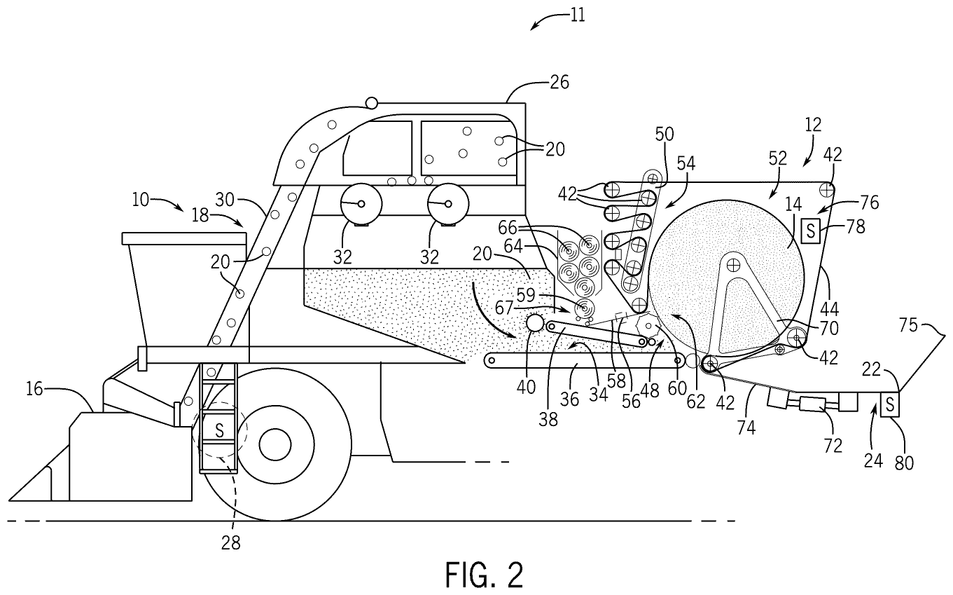

FIG. 2 is a schematic view of an embodiment of an agricultural product transport assembly 11, an embodiment of a baler 12, and an embodiment of a bale handler system 24 that may be employed within the agricultural harvester 10 of FIG. 1. As previously discussed, the header 16 of the agricultural harvester 10 includes row units that harvest the agricultural product 20 (e.g., cotton, hay, straw, fodder) from the field. Furthermore, the air-assisted conveying system 18 moves the agricultural product 20 from the row units of the header 16 to the accumulator assembly 26. In the illustrated embodiment, the air-assisted conveying system 18 includes a conveying air source 28 that outputs a conveying air flow through one or more ducts 30. Each duct 30 receives the agricultural product 20 (e.g., cotton) from the header 16, and the conveying air flow output by the conveying air source 28 drives the agricultural product to move through the duct(s) 30 from the header 16 to the accumulator assembly 26. In the illustrated embodiment, the agricultural product transport assembly 11 includes augers 32 that distribute the agricultural product 20 (e.g., cotton) laterally across the accumulator assembly 26 (e.g., crosswise to the downward movement of the agricultural product through the accumulator assembly). In the illustrated embodiment, the agricultural product transport assembly 11 includes two augers 32. However, in other embodiments, the agricultural product transport assembly may include more or fewer augers (e.g., 0, 1, 3, 4, or more).

In the illustrated embodiment, the conveying system 34 of the agricultural product transport assembly 11 includes a first belt (e.g., belt) 36 that moves the agricultural product 20 from the accumulator assembly 26 to the baler 12. The first belt 36 rotates in a first rotational direction to move an agricultural product engaging surface of the first belt 36 toward the baler 12. Furthermore, in the illustrated embodiment, the conveying system 34 includes a second belt 38 positioned on an opposite side of the agricultural product 20 from the first belt 36, and the second belt 38 cooperates with the first belt 36 to move the agricultural product 20 from the accumulator assembly 26 to the baler 12. Furthermore, in the illustrated embodiment, the conveying system 34 includes an agitation roller 40 positioned upstream of the second belt 38. The agitation roller 40 agitates the agricultural product 20 entering the pair of opposing belts, thereby enhancing the uniformity of the distribution of the agricultural product passing through the pair of opposing belts.

In the illustrated embodiment, the baler 12 includes multiple rollers 42 that support and/or drive rotation of one or more belts 44. For example, one or more rollers 42 engage the belt(s) 44, which enable the belt(s) 44 to move along the pathway defined by the rollers 42 and the bale 14. One or more rollers 42 are driven to rotate via a belt drive system (e.g., including electric motor(s), hydraulic motor(s), pneumatic motor(s), etc.). The belt(s) 44 circulate around the pathway defined by the rollers 42 and the bale 14. Movement of the belt(s) 44 captures agricultural product 20 from the conveying system 34 and draws the agricultural product 20 into a cavity 48, where the agricultural product 20 is gradually built up to form the bale 14.

In the illustrated embodiment, the baler 12 includes a tension arm 50 that establishes tension within the belt(s) 44. As the agricultural product 20 builds within the cavity 48, the agricultural product 20 applies a force to the belt(s) 44 that urges a first portion 52 of the belt(s) 44 surrounding the bale 14 to expand. Concurrently, the size of a second portion 54 (e.g., serpentine portion) of the belt(s) 44 is reduced. Accordingly, the second portion 54 of the belt(s) 44 provides the increasing belt length for the expanding first portion 52. In the illustrated embodiment, the second portion 54 of the belt(s) 44 is established by fixed rollers 42 (e.g., rollers fixed to a housing/frame of the baler 12) and rollers 42 coupled to the tension arm 50, which is pivotable relative to the fixed rollers 42 (e.g., relative to the housing/frame of the baler 12). Accordingly, as the agricultural product 20 builds within the cavity 48, the tension arm 50 is driven to rotate, thereby reducing the size of the second portion 54 and enabling the first portion 52 to expand.

Once the bale 14 reaches a desired size, a bale wrapping system 56 wraps the bale 14 with a section of a bale wrap 58 of an active bale wrap assembly 59 to secure the agricultural product within the bale 14 and to generally maintain a shape of the bale 14, such as the round shape in the illustrated embodiment. The bale wrap 58 may include a substrate in the form of a plastic film, an organic film, a net, a series of twine segments, or any other suitable structure. The bale wrap 58 may be fed into contact with the bale 14 using one or more rollers and/or one or more belts of a bale wrap feeding assembly. The roller(s) and/or the belt(s) drive the bale wrap 58 toward a starter roller 60 (e.g., bale wrap feeder). The starter roller 60 rotates to feed the bale wrap 58 into the cavity 48 of the baler 12 at a feeding location 62, thereby driving the bale wrap 58 into contact with the bale 14. The bale wrap 58 is captured between the bale 14 and the belt(s) 44. Accordingly, rotation of the bale 14 draws the bale wrap 58 around the bale 14, thereby wrapping the bale 14. After the bale 14 is wrapped, the bale 14 is ejected from the baler 12, and the process of forming a subsequent bale may be initiated. While the starter roller 60 feeds the bale wrap 58 into the cavity 48 in the illustrated embodiment, in other embodiments, the agricultural harvester may include another suitable bale wrap feeder that feeds the bale wrap into the cavity. For example, in certain embodiments, the agricultural harvester may include a movable wrap guide (e.g., duck bill) that engages the bale wrap while the movable wrap guide is in a first position and moves to a second position to feed the bale wrap into the cavity at the feeding location.

In certain embodiments, during the harvesting process, the conveying system 34 and the baler 12 may be periodically activated to transfer the agricultural product 20 from the accumulator assembly 26 to the baler 12 and to form the bale 14. For example, as the agricultural harvester 10 traverses a field, the agricultural product 20 may accumulate within the accumulator assembly 26. After a selected duration, the conveying system 34 may be activated to transfer the agricultural product 20 from the accumulator assembly 26 to the baler 12. For example, the conveying system 34 may move the agricultural product 20 toward the baler 12 at a significantly faster rate than the air-assisted conveying system 18 moves the agricultural product 20 into the accumulator assembly 26. Concurrently with activation of the conveying system 34, the baler 12 may be activated to initiate the bale forming process, as described above. After another selected duration, the conveying system 34 and the baler 12 may be deactivated to enable the accumulator assembly 26 to collect additional agricultural product 20. In certain embodiments, the conveying system 34 and the baler 12 may be activated four or five times to enable the bale 14 to reach the desired size. As previously discussed, once the bale reaches the desired size, the bale wrapping system 56 wraps the bale 14 with the bale wrap 58. Because the conveying system 34 and the baler 12 are periodically activated, the agricultural harvester 10 may utilize less energy during the harvesting process (e.g., as compared to continuously operating the conveying system and the baler).

In the illustrated embodiment, the agricultural harvester 10 includes a bale wrap assembly storage compartment 64 that stores multiple bale wrap assemblies 66. In certain embodiments, each bale wrap assembly 66 includes a shaft and a bale wrap disposed about the shaft to form a roll of the bale wrap. However, in other embodiments, the shaft may be omitted, and the bale wrap of the bale wrap assembly may be arranged in a roll (e.g., with a hollow region at the center). Furthermore, in certain embodiments, the agricultural harvester includes a bale wrap assembly transport system that moves a bale wrap assembly 66 from the bale wrap assembly storage compartment 64 (e.g., at the bottom of the bale wrap assembly storage compartment 64) into a usage location 67. The bale wrap assembly within the usage location 67 becomes the active bale wrap assembly 59, and, as discussed above, the bale wrap 58 of the active bale wrap assembly 59 is fed into contact with the bale 14 to wrap the bale 14.

The bale wrap assemblies 66 may be loaded into the bale wrap assembly storage compartment 64 via an opening at the top of the bale wrap assembly storage compartment 64. For example, a crane may move each bale wrap assembly 66 from a ground surface to the bale wrap assembly storage compartment 64 by lifting the bale wrap assembly 66 upwardly, moving the bale wrap assembly to a position over the opening at the top of the bale wrap assembly storage compartment, and lowering the bale wrap assembly into the bale wrap assembly storage compartment. Furthermore, in certain embodiments, the bale wrap assemblies may be loaded into the bale wrap assembly storage compartment manually. While the agricultural harvester 10 includes a bale wrap assembly storage compartment 64 that stores multiple bale wrap assemblies 66 in the illustrated embodiment, in other embodiments, the bale wrap assembly storage compartment may store a single bale wrap assembly. Furthermore, in certain embodiments, the bale wrap assembly storage compartment may be omitted. In such embodiments, the bale wrap assembly (e.g., the active bale wrap assembly) may be loaded directly into the usage location (e.g., manually, via a crane, etc.).

Each bale 14 is wrapped with a section of the bale wrap 58 of the active bale wrap assembly 59. In certain embodiments, the bale wrap 58 of each bale wrap assembly is segmented, in which each segment of the bale wrap corresponds to a respective section that wraps around the bale. In certain embodiments, a segmented bale wrap includes multiple bale wrap segments that each wrap a respective bale and weakened sections that are each positioned between adjacent bale wrap segments to facilitate separation of the bale wrap segments. In such embodiments, in response to determining the weakened section of the bale wrap 58 is positioned between the shaft/center hollow region of the active bale wrap assembly 59 and the bale 14, the bale wrapping system 56 controls a braking system to establish a tension force at the weakened section of the bale wrap 58 sufficient to separate a first segment of the bale wrap disposed about the bale 14 from a second segment of the bale wrap 58 disposed about the shaft/center hollow region of the active bale wrap assembly 59, thereby facilitating completion of the bale wrapping process and ejection of the wrapped bale. Furthermore, in certain embodiments, the bale wrap 58 of each bale wrap assembly is continuous. In such embodiments, in response to determining an interface between an end of a first section and a beginning of a second section is positioned at a cutting system (e.g., by identifying a cut location indicator on the bale wrap), the bale wrapping system 56 controls the cutting system to separate the first section, which is disposed about the bale 14, from the second section, which is disposed about the shaft/center hollow region of the active bale wrap assembly 59, thereby facilitating completion of the bale wrapping process and ejection of the wrapped bale.

Furthermore, the agricultural harvester 10 includes a bale ejection system that ejects the bale 14 from the baler 12 into the bale handler 22 of the bale handler system 24. In certain embodiments, the bale ejection system includes one or more actuators that drive pendulum arms 70 of the baler 12 to rotate upwardly from the illustrated bale formation position to a bale ejection position. As the pendulum arms 70 rotate upwardly toward the bale ejection position, the rollers 42 coupled to the pendulum arms 70 move the belt(s) at a rear portion of the baler 12, thereby forming a gap sufficiently large for the wrapped bale to exit the cavity 48 of the baler 12. In addition, the tension within the belt(s) 44, which is established by the tension arm 50, causes the belt(s) to drive the wrapped bale out of the cavity 48 as the pendulum arms 70 rotate upwardly. Accordingly, the wrapped bale is ejected from the cavity 48 of the baler 12 as the pendulum arms 70 rotate upwardly from the illustrated bale formation position to the bale ejection position. While a bale ejection system having actuator(s) that drive the pendulum arms 70 to rotate is disclosed above, in certain embodiments, the bale ejection system may include any other suitable device(s) that eject the bale from the cavity, such as one or more actuators that drive a door positioned at a rear of the baler to open.

In addition, the bale handler 22 of the bale handler system 24 receives the bale 14 from the baler 12 as the bale 14 is ejected from the baler 12. In the illustrated embodiment, the bale handler system 24 includes a hydraulic cylinder 72 coupled to the bale handler 22 and to a ramp 74 that is coupled to the chassis of the agricultural harvester 10. The hydraulic cylinder 72 drives the bale handler 22 from the illustrated receiving position to a discharge position. While the bale handler is in the illustrated receiving position, the bale handler 22 may receive the bale 14 from the baler 12 (e.g., via the ramp 74) and support the bale 14 (e.g., for transport to a desired discharge location). Furthermore, the hydraulic cylinder 72 drives the bale handler 22 to rotate downwardly such that a distal end 75 of the bale handler 22 is positioned at or adjacent to the surface of the field. As the bale handler 22 rotates downwardly, the bale 14 supported by the bale handler 22 may roll downwardly along the bale handler 22 to the surface of the field. After the bale 14 is discharged, the hydraulic cylinder 72 may drive the bale handler 22 back to the illustrated receiving position to receive a subsequent bale 14. Furthermore, in certain embodiments, the hydraulic cylinder 72 may drive the bale handler 22 to rotate upwardly from the illustrated receiving position to a transport position (e.g., home position), thereby reducing the length of the agricultural harvester during harvesting operations. While the bale handler system 24 includes a single hydraulic cylinder 72 in the illustrated embodiment, in other embodiments, the bale handler system may include multiple hydraulic cylinders and/or one or more other suitable type(s) of actuators, such as pneumatic cylinder(s), electric linear actuator(s), other suitable type(s) of actuator(s), or a combination thereof.

As discussed in detail below, the bale wrap 58 includes a bale wrap substrate and multiple bale identifiers disposed on or within the bale wrap substrate. In certain embodiments, each bale identifier includes an image, such as a bar code, a quick response (QR) code, a data matrix, etc. In addition, each bale identifier includes data indicative of a bale code, thereby facilitating identification of the wrapped bale in the field. In the illustrated embodiment, the agricultural harvester 10 includes a bale identification system 76 that scans a bale identifier and associates a bale with a respective bale code, which corresponds to the scanned bale identifier. As discussed in detail below, the bale identification system 76 includes one or more scanners directed to a region external to the agricultural harvester 10. Each scanner scans a bale identifier of the bale wrap 58 while a section of the bale wrap is disposed about a bale in the field. The scanner outputs a signal indicative of a respective bale code, which corresponds to the scanned bale identifier. In addition, the bale identification system 76 includes a controller communicatively coupled to the scanner. The controller includes a processor and a memory, and the controller receives the signal indicative of the respective bale code and associates the bale with the respective bale code. Accordingly, the bale identification system may identify a bale in the field (e.g., after the bale is discharged from the bale handler system 24).

In the illustrated embodiment, the bale identification system 76 includes a first scanner 78 and a second scanner 80. The first scanner 78 is coupled to the frame of the agricultural harvester 10 and is positioned above the second scanner 80. The first scanner 78 may be directed downwardly toward the field, thereby enabling the first scanner to scan a bale identifier positioned toward a top of the wrapped bale on the surface of the field (e.g., after the bale is discharged from the bale handler system 24). In addition, the second scanner 80 is coupled to the bale handler 22 of the bale handler system 24. Accordingly, the second scanner 80 is positioned below the first scanner 78. The second scanner 80 may be directed rearwardly, thereby enabling the second scanner to scan a bale identifier positioned toward a front side of the wrapped bale on the surface of the field (e.g., after the bale is discharged from the bale handler 24). Accordingly, the bale identification system 76 may scan bale identifiers at multiple locations on the wrapped bale while the bale is in the field. While the first scanner 78 is coupled to the frame of the agricultural harvester and positioned above the second scanner 80 in the illustrated embodiment, in other embodiments, the first scanner may be positioned at another suitable location on the agricultural harvester. Furthermore, while the second scanner 80 is coupled to the bale handler 22 in the illustrated embodiment, in other embodiments, the second scanner may be positioned at another suitable location on the agricultural harvester. In addition, while the bale identification system 76 includes two scanners in the illustrated embodiment, in other embodiments, the bale identification system may include more or fewer scanners.

While the bale identification system and the bale wrap are disclosed herein with regard to an agricultural harvester having a header, an air-assisted conveying system, an accumulator, and a conveying system, in certain embodiments, the bale identification system and/or any bale wrap disclosed herein may be employed within another suitable type of agricultural harvester. For example, in certain embodiments, the agricultural harvester may include a pickup mechanism that feeds the agricultural product from the ground to the baler. In such embodiments, the header, the air-assisted conveying system, the accumulator, and the conveying system may be omitted.

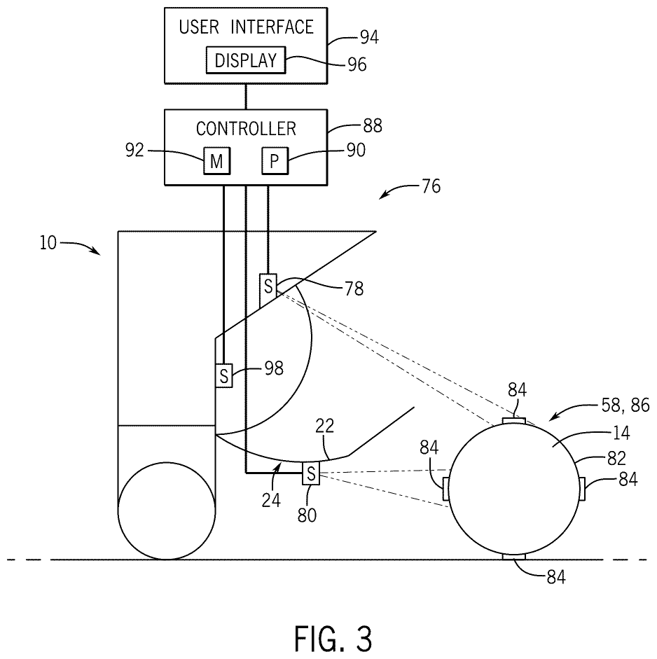

FIG. 3 is a block diagram of an embodiment of a bale identification system 76 that may be employed within the baler of FIG. 2. As discussed in detail below, the bale wrap 58 includes a bale wrap substrate 82 and multiple bale identifiers 84 disposed on or within the bale wrap substrate 82. In certain embodiments, each bale identifier 84 includes an image, and each bale identifier 84 includes data indicative of a bale code. Furthermore, as previously discussed, each scanner is directed to a region external to the agricultural harvester 10, each scanner scans a bale identifier 84 of the bale wrap 58 while a section 86 of the bale wrap 58 is disposed about the bale 14 in the field, each scanner outputs a signal indicative of a respective bale code, and the respective bale code corresponds to the bale identifier 84. Each scanner may include any suitable device(s) suitable for scanning bale identifiers. In embodiments in which each bale identifier includes an image (e.g., bar code, QR code, data matrix), the scanner may include an optical scanner. For example, in certain embodiments, at least one scanner may include a camera that monitors other suitable parameter(s) associated with operation of the agricultural harvester, in addition to scanning bale identifiers. As used herein, a respective bale code corresponding to a bale identifier, refers to the bale identifier including data indicative of the respective bale code.

As illustrated, the first scanner 78 of the bale identification system 76 is coupled to the frame of the agricultural harvester 10, and the first scanner 78 is directed downwardly toward the field, thereby enabling the first scanner 78 to scan a bale identifier 84 positioned toward a top of the wrapped bale on the surface of the field (e.g., after the bale is discharged from the bale handler system 24). In addition, the second scanner 80 is coupled to the bale handler 22 of the bale handler system 24, and the second scanner 80 is directed rearwardly, thereby enabling the second scanner to scan a bale identifier 84 positioned toward a front side of the wrapped bale on the surface of the field (e.g., after the bale is discharged from the bale handler 24). In certain embodiments, the bale identifiers may be positioned proximate to one another such that at least one scanner may scan multiple bale identifiers. While the bale identification system 76 includes two scanners in the illustrated embodiment, in other embodiments, the bale identification system may include more or fewer scanners. For example, in certain embodiments, the bale identification system may only include the first scanner, or the bale identification system may only include the second scanner.

In the illustrated embodiment, the bale identification system 76 includes a controller 88 communicatively coupled to the first scanner 78 and to the second scanner 80. In certain embodiments, the controller 88 is an electronic controller having electrical circuitry that receives the signal(s) indicative of the respective bale code(s) from the scanner(s). In the illustrated embodiment, the controller 88 includes a processor 90, such as a microprocessor, and a memory device 92. The controller 88 may also include one or more storage devices and/or other suitable components. The processor 90 may be used to execute software, such as software for identifying the bale 14, and so forth. Moreover, the processor 90 may include multiple microprocessors, one or more “general-purpose” microprocessors, one or more special-purpose microprocessors, and/or one or more application specific integrated circuits (ASICs), or some combination thereof. For example, the processor 90 may include one or more reduced instruction set (RISC) processors.

The memory device 92 may include a volatile memory, such as random access memory (RAM), and/or a nonvolatile memory, such as read-only memory (ROM). The memory device 92 may store a variety of information and may be used for various purposes. For example, the memory device 92 may store processor-executable instructions (e.g., firmware or software) for the processor 90 to execute, such as instructions for identifying the bale 14, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for identifying the bale 14, etc.), and any other suitable data.

In the illustrated embodiment, the bale identification system 76 includes a user interface 94 communicatively coupled to the controller 88. The user interface 94 receives input from an operator and provides information to the operator. The user interface 94 may include any suitable input device(s) for receiving input, such as a keyboard, a mouse, button(s), switch(es), knob(s), other suitable input device(s), or a combination thereof. In addition, the user interface 94 may include any suitable output device(s) for presenting information to the operator, such as speaker(s), indicator light(s), other suitable output device(s), or a combination thereof. In the illustrated embodiment, the user interface 94 includes a display 96 that presents visual information to the operator. In certain embodiments, the display 96 may include a touchscreen interface that receives input from the operator.

The controller 88 receives the signal(s) indicative of the respective bale code(s) from the scanner(s). In addition, the controller 88 associates the bale 14 with the respective bale code(s). Accordingly, the bale identification system 76 may identify a bale in the field (e.g., after the bale is discharged from the bale handler system 24). In the illustrated embodiment, the bale identification system 76 does not include a scanner directed toward a bale within the agricultural harvester (e.g., within the baler, within the bale handler). Accordingly, the bale identification system 76 is not capable of identifying a bale during the baling process (e.g., during the bale wrapping process) or while the bale is on the bale handler.

As discussed in detail below, in certain embodiments, the bale identifiers 84 are arranged in multiple patterns on the bale wrap 58. Each pattern is formed by a set of two or more bale identifiers 84, and each pattern extends along a length of the bale wrap equal to a minimum bale circumference. In addition, the patterns do not overlap one another along the length of the bale wrap, and the bale identifiers of each set of bale identifiers include data indicative of a common bale code. Accordingly, for a bale having the minimum bale circumference, one or two sets of bale identifiers are positioned on the exterior of the wrapped bale. In certain embodiments, the controller 88 of the bale identification system 76 associates the bale 14 with a preceding bale code and with a succeeding bale code, in addition to the bale code corresponding to the scanned bale identifier. The preceding bale code corresponds to a preceding bale identifier (e.g., bale identifier of a preceding set of bale identifiers), and the succeeding bale code corresponds to a succeeding bale identifier (e.g., bale identifier of a succeeding set of bale identifiers). Accordingly, if bale identifiers of one set, including the scanned bale identifier, and bale identifiers of the preceding set are positioned on the exterior of the wrapped bale, the bale may be identified by scanning a bale identifier of the one set or a bale identifier of the preceding set during subsequent bale identification. In addition, if bale identifiers of one set, including the scanned bale identifier, and bale identifiers of the succeeding set are positioned on the exterior of the wrapped bale, the bale may be identified by scanning a bale identifier of the one set or a bale identifier of the succeeding set during subsequent bale identification.

In the illustrated embodiment, the bale identification system 76 includes a bale sensor assembly 98 communicatively coupled to the controller 88. The bale sensor assembly 98 monitors one or more properties of the bale 14 before the wrapped bale is ejected from the agricultural harvester 10. For example, the bale sensor assembly 98 may include a weight sensor that monitors a weight of the bale, a moisture sensor that monitors a moisture content of the agricultural product within the bale, a size sensor that monitors a diameter of the bale, other suitable sensor(s), or a combination thereof. The bale sensor assembly 98 outputs signal(s) indicative of the one or more properties of the bale, and the controller 88 determines bale information for the bale, in which the bale information includes the one or more properties of the bale. While the bale identification system 76 includes the bale sensor assembly 98 in the illustrated embodiment, in other embodiments, the bale sensor assembly may be omitted.

In certain embodiments, the controller establishes a database including an entry for each bale. As previously discussed, while a bale is in the field (e.g., after the bale has been discharged from the bale handler system), a scanner scans a bale identifier of the bale wrap section disposed about the bale. The scanner outputs a signal indicative of a respective bale wrap code, which corresponds to the bale identifier, and the controller 88 receives the signal indicative of the respective bale code and associates the bale with the respective bale code. The controller 88 may then add an entry to the database for the bale, in which the entry includes the bale code. Accordingly, the controller 88 establishes a database with one entry per bale, in which each entry includes the respective bale code. Furthermore, in embodiments in which the controller 88 associates the bale with the preceding bale code and the succeeding bale code, as disclosed above, the controller 88 also adds the preceding bale code and the succeeding bale code to the entry. Accordingly, the controller 88 establishes a database with one entry per bale, in which each entry includes the respective bale code, the preceding bale code, and the succeeding bale code. In addition, in embodiments in which the bale identification system 76 includes the bale sensor assembly 98, the controller may also include the bale information for each bale in the respective entry.

In certain embodiments, the controller 88 may instruct the user interface 94 to present information from the database on the display 96. For example, the controller 88 (e.g., in response to user input) may instruct the display 96 of the user interface 94 to present the database in a table form. The table may have rows corresponding to the entries of the database, and the table may have columns corresponding to the information within the entries. For example, in certain embodiments, the columns may include bale code(s) (e.g., the respective bale code alone, or the respective bale code, the preceding bale code, and the subsequent bale code) and, in certain embodiments, the bale information.

Furthermore, in certain embodiments, the bale identification system may include a transceiver communicatively coupled to the controller, in which the transceiver outputs a wireless signal indicative of the database. The wireless signal indicative of the database may be received by a remote system via a respective transceiver, and the database may be stored on the remote system. The remote system may include a scanner that scans the bale identifiers. Accordingly, the remote system may scan a bale identifier of a section of bale wrap disposed about a bale, and the database may enable the remote system to identify the bale based on the bale code corresponding to the scanned bale identifier. Furthermore, in certain embodiments, the controller may output a signal indicative of the database to the remote system via a wired connection (e.g., the remote system may be temporarily connected to the bale identification system with the wired connection). In addition, in certain embodiments, the bale identification system may include a removable media writer communicatively coupled to the controller, in which the removable media writer writes the database to a removable medium. In such embodiments, the remote system may include a removable media reader that reads the removable medium, thereby providing the database to the remote system. Furthermore, in certain embodiments, the controller outputs (e.g., via the respective transceiver) a wireless signal indicative of the database to a remote server (e.g., a cloud-based server, etc.), and the remote server may receive the wireless signal (e.g., via a respective transceiver) and store the database. In such embodiments, the remote system may receive a wireless signal indicative of the database (e.g., via the respective transceiver) from the remote system.

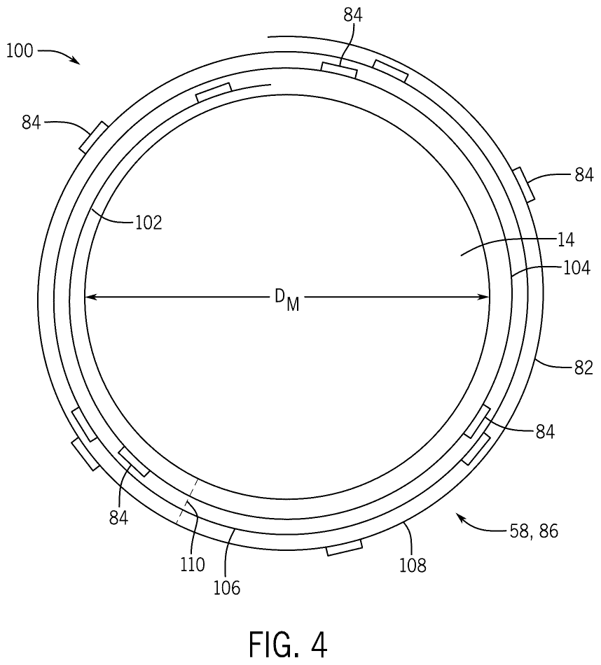

FIG. 4 is a schematic side view of an embodiment of a wrapped bale 100 that may be identified by the bale identification system of FIG. 3. As illustrated, the wrapped bale 100 includes the bale 14 of agricultural product and a section 86 of a bale wrap 58 disposed about the bale 14. In the illustrated embodiment, the bale wrap section 86 extends about a circumference of the bale 14 three times, thereby forming three layers of bale wrap 58 over the bale 14. However, in other embodiments, the bale wrap section may form more or fewer layers of bale wrap over the bale (e.g., 2, 4, 5, 6, 7, 8, or more). For example, in certain embodiments, the bale wrap section may extend about the circumference of the bale five times, thereby forming five layers of bale wrap over the bale.

As previously discussed, the bale wrap 58 includes a substrate 82 and multiple bale identifiers 84 disposed on or within the bale wrap substrate 82. In certain embodiments, each bale identifier 84 includes an image disposed on the bale wrap substrate 82. For example, the image may be printed directly onto the bale wrap substrate 82 or the image may be printed onto a sticker applied to the bale wrap substrate 82. Furthermore, in certain embodiments, each bale identifier 82 may include an image disposed within the bale wrap substrate 82. For example, the image may be etched or engraved into the bale wrap substrate 82. The image may include any suitable image (e.g., bar code, QR code, data matrix, etc.) that may be scanned by a suitable scanner.

In the illustrated embodiment, the bale identifiers 84 are arranged in multiple patterns, and each pattern is formed by a set of two or more bale identifiers 84. In addition, each pattern extends along a length of the bale wrap 58 equal to a minimum bale circumference, and the patterns do not overlap one another along the length of the bale wrap. Furthermore, the bale identifiers 84 of each set of bale identifiers include data indicative of a common bale code. Accordingly, for a bale having the minimum bale circumference, one or two sets of bale identifiers are positioned on the exterior of the wrapped bale 100.

In the illustrated embodiment, the bale 14 has a minimum bale diameter D_{M}, thereby establishing the minimum bale circumference. For example, in certain embodiments, the minimum bale diameter D_{M} may be 4 feet (e.g., 1.22 m). Accordingly, the minimum bale circumference may be 12.56 feet (e.g., 3.83 m), and the length of each pattern of bale identifiers 84 may be 12.56 feet (e.g., 3.83 m). In the illustrated embodiment, the bale wrap 58 may be continuous. Accordingly, each end of the bale wrap section 86 may be cut along any portion of the respective pattern. As a result, one or two sets of bale identifiers may be positioned on the exterior of the wrapped bale 100, and the remainder of the sets of bale identifiers of the bale wrap section 86 are disposed below the outermost layer of the bale wrap section 86. In the illustrated embodiment, bale identifiers 84 of a first set are arranged in a first pattern on a first portion 102 of the bale wrap section 86, bale identifiers of a second set are arranged in a second pattern on a second portion 104 of the bale wrap section 86, bale identifiers of a third set are arranged in a third pattern on a third portion 106 of the bale wrap section 86, and bale identifiers of a fourth set are arranged in a fourth pattern on a fourth portion 108 of the bale wrap section 86. A dashed line 110 indicates the interfaces between the portions. The patterns within the portions may be the same as one another or different than one another. As illustrated, the fourth portion 108 and part of the third portion 106 of the bale wrap section 86 form the exterior circumferential surface of the wrapped bale 100. Accordingly, the bale identifiers 84 of the third set and the bale identifiers 84 of the fourth set may be scanned by a scanner of the bale identification system. In addition, the bale identifiers 84 of the second set and the bale identifiers 84 of the first set may be at least partially obscured by the bale wrap substrate 82 disposed over the bale identifiers 84 of the first and second sets. Accordingly, the bale identifiers 84 of the first set and the bale identifiers 84 of the second set may not be scanned by a scanner of the bale identification system.

The controller of the bale identification system associates the bale 14 with a preceding bale code and with a succeeding bale code, in addition to the bale code corresponding to the scanned bale identifier. The preceding bale code corresponds to a preceding bale identifier 84 (e.g., bale identifier of a preceding set of bale identifiers), and the succeeding bale code corresponds to a succeeding bale identifier 84 (e.g., bale identifier of a succeeding set of bale identifiers). For example, if a bale identifier 84 of the third set is scanned, the controller associates the bale 14 with the bale code corresponding to the bale identifiers 84 of the third set, the bale code corresponding to the bale identifiers 84 of the second set, and the bale code corresponding to the bale identifiers 84 of the fourth set. Accordingly, the bale 14 may be identified by scanning any bale identifier 84 of the third set or any bale identifier 84 of the fourth set, which are the bale identifiers 84 positioned on the exterior circumference of the wrapped bale 100. The bale identifiers 84 of the second set may not be scanned because the bale identifiers are at least partially obscured by the bale wrap substrate 82. Furthermore, if a bale identifier 84 of the fourth set is scanned, the controller associates the bale 14 with the bale code corresponding to the bale identifiers 84 of the fourth set, the bale code corresponding to the bale identifiers 84 of the third set, and the bale code corresponding to the bale identifiers 84 of a fifth set. Accordingly, the bale 14 may be identified by scanning any bale identifier 84 of the third set or any bale identifier 84 of the fourth set, which are the bale identifiers 84 positioned on the exterior circumference of the wrapped bale 100. The bale identifiers 84 of the fifth set may not be scanned because the bale identifiers are at least partially obscured by the bale wrap substrate of the bale wrap segment disposed about a subsequent bale.

As previously discussed, the bale wrap substrate 82 may be in the form of a plastic film, an organic film, a net, a series of twine segments, or any other suitable structure. In certain embodiments, the bale wrap substrate 82 is substantially opaque (e.g., greater than 90 percent opaque). In such embodiments, the bale identifiers 84 positioned below at least one layer of the bale wrap section 86 may be substantially or completely obscured by the bale wrap substrate 82. Furthermore, in certain embodiments, the bale wrap substrate 82 may be translucent. In such embodiments, the bale identifiers 84 positioned below at least one layer of the bale wrap section 86 may be partially obscured by the bale wrap substrate 82.

As previously discussed, the bale identifiers 84 of each set of bale identifiers include data indicative of a common bale code. In certain embodiments, each bale identifier may also include data indicative of a respective bale identifier code. In such embodiments, each bale identifier may be uniquely identifiable based on the data indicative of the respective bale code and the data indicative of the respective bale identifier code. Furthermore, in certain embodiments, the bale identifiers of each set may include data indicative of different bale codes, in which the bale codes corresponding to the respective bale identifiers of the set are associated with one another (e.g., within the controller of the bale identification system). Accordingly, in response to scanning one bale identifier of a set, the controller may associate the bale with the bale codes corresponding to the respective bale identifiers of the set, and in certain embodiments, with the bale codes corresponding to the respective bale identifiers of the preceding set and the bale codes corresponding to the respective bale identifiers of the succeeding set.

While a bale wrap section having one or two sets of bale identifiers positioned on the exterior of the wrapped bale is disclosed above, in certain embodiments, two or three sets of bale identifiers may be positioned on the exterior of the wrapped bale (e.g., if the illustrated bale wrap section is wrapped around a bale having a circumference greater than the minimum bale circumference, if a bale wrap section having patterns that extend along the length of the bale wrap less than the minimum bale circumference is wrapped around a bale having the minimum bale circumference, etc.). In such embodiments, the controller may associate the bale with the bale code corresponding to the scanned bale identifier, with two preceding bale codes, and with two succeeding bale codes. The first preceding bale code corresponds to a first preceding bale identifier (e.g., bale identifier of a first preceding set of bale identifiers), the second preceding bale code corresponds to a second proceeding bale identifier (e.g., bale identifier of a second preceding set of bale identifiers), the first succeeding bale code corresponds to a first succeeding bale identifier (e.g., bale identifier of a first succeeding set of bale identifiers), and the second succeeding bale code corresponds to a second succeeding bale identifier (e.g., bale identifier of a second succeeding set of bale identifiers). Accordingly, if bale identifiers of one set, including the scanned bale identifier, and bale identifiers of the two preceding sets are positioned on the exterior of the wrapped bale, the bale may be identified by scanning a bale identifier of the one set, a bale identifier of the first preceding set, or a bale identifier of the second preceding set during subsequent bale identification.

In addition, if bale identifiers of one set, including the scanned bale identifier, and bale identifiers of the two succeeding sets are positioned on the exterior of the wrapped bale, the bale may be identified by scanning a bale identifier of the one set, a bale identifier of the first succeeding set, or a bale identifier of the second succeeding set during subsequent bale identification. Furthermore, if bale identifiers of one set, including the scanned bale identifier, bale identifiers of the first succeeding set, and bale identifiers of the first preceding set are positioned on the exterior of the wrapped bale, the bale may be identified by scanning a bale identifier of the one set, a bale identifier of the first succeeding set, or a bale identifier of the first preceding set during subsequent bale identification. The same technique may be applied to bale wrap sections in which additional sets of bale identifiers are positioned on the exterior of the wrapped bale.

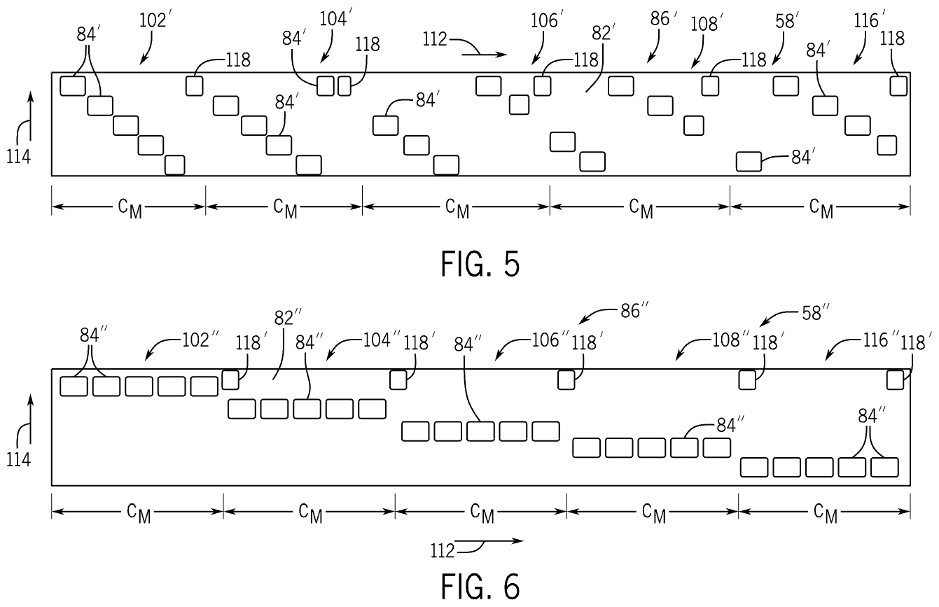

FIG. 5 is a schematic view of an embodiment of a section 86′ of a bale wrap 58′ that may be disposed about a bale, in which the bale wrap includes bale identifiers 84′ that may be scanned by the bale identification system of FIG. 3. As previously discussed, the bale wrap 58′ includes a bale wrap substrate 82′, and the bale identifiers 84′ are disposed on or within the bale wrap substrate 82′. As illustrated, the bale identifiers 84′ are arranged in multiple patterns, each pattern includes two or more bale identifiers 84′, each pattern extends along a length 112 of the bale wrap 58′ equal to the minimum bale circumference C_{M}, and the patterns do not overlap one another along the length 112 of the bale wrap 58′.

In the illustrated embodiment, each pattern may be different than an adjacent pattern such that each bale identifier 84′ of the set of bale identifiers of the pattern does not overlap any bale identifier of the set of bale identifiers of the adjacent pattern while the section 86′ of the bale wrap 58′ having the pattern and the adjacent pattern is wrapped around a bale having the minimum bale circumference. Accordingly, in embodiments in which the bale wrap substrate is not completely opaque, the possibility of a bale identifier of an inner layer of the bale wrap section 86′ interfering with scanning of a bale identifier on the outer layer of the bale wrap section 86′ is substantially reduced or eliminated, thereby facilitating identification of the bale. As used herein, “pattern” refers to an arrangement of the bale identifiers (e.g., set of bale identifiers) on the bale wrap.

In the illustrated embodiment, the bale wrap 58′ is continuous. Accordingly, each end of the bale wrap section 86′ may be cut along any portion of a respective pattern. Furthermore, the patterns include a number of different patterns equal to a maximum number of layers of bale wrap 58′ around the bale having the minimum bale circumference. In the illustrated embodiment, the bale wrap 58′ has five different patterns because each section 86′ of the bale wrap 58′ wraps around the bale having the minimum bale circumference five times. However, in other embodiments (e.g., in embodiments in which the bale wrap section wraps around the bale having the minimum bale circumference more or fewer times), the bale wrap may have more or fewer patterns. For example, if each bale wrap section wraps around the bale having the minimum bale circumference four times, the bale wrap may have four different patterns, and if each bale wrap section wraps around the bale having the minimum bale circumference six times, the bale wrap may have six different patterns.

Furthermore, in certain embodiments, each bale wrap section may include more or fewer patterns than the number of times the bale wrap section wraps around the bale having the minimum bale circumference. In the illustrated embodiment, the bale identifiers 84′ (e.g., the set of bale identifiers 84′) of each pattern are distributed along the length 112 of the bale wrap 58′′and along a width 114 of the bale wrap 58′. However, in other embodiments, the bale identifiers of each pattern may be arranged in another suitable configuration.

In the illustrated embodiment, the bale identifiers 84′ of a first set are arranged in a first pattern on a first portion 102′ of the bale wrap section 86′. As illustrated, the first set includes five bale identifiers 84′ arranged diagonally along the length 112 and the width 114 of the bale wrap 58′. Furthermore, the bale identifiers 84′ of a second set are arranged in a second pattern on a second portion 104′ of the bale wrap section 86′. As illustrated, the second set also includes five bale identifiers 84′, in which four bale identifiers 84′ are arranged diagonally along the length 112 and the width 114 of the bale wrap 58′, and one bale identifier 84′ is laterally and longitudinally offset from the other four bale identifiers 84′.

In addition, the bale identifiers 84′ of a third set are arranged in a third pattern on a third portion 106′ of the bale wrap section 86′. As illustrated, the third set also includes five bale identifiers 84′ in which a first group of three bale identifiers 84′ are arranged diagonally along the length 112 and the width 114 of the bale wrap section 86′, a second group of two bale identifiers 84′ are arranged diagonally along the length 112 and the width 114 of the bale wrap section 86′, and the two groups are laterally and longitudinally offset from one another. Furthermore, the bale identifiers 84′ of a fourth set are arranged in a fourth pattern on a fourth portion 108′ of the bale wrap section 86′. As illustrated, the fourth set also includes five bale identifiers 84′ in which a first group of two bale identifiers 84′ are arranged diagonally along the length 112 and the width 114 of the bale wrap section 86′, a second group of three bale identifiers 84′ are arranged diagonally along the length 112 and the width 114 of the bale wrap section 86′, and the two groups are laterally and longitudinally offset from one another. In addition, the bale identifiers 84′ of a fifth set are arranged in a fifth pattern on a fifth portion 116′ of the bale wrap section 86′. As illustrated, the fifth set also includes five bale identifiers 84′ in which four bale identifiers 84′ are arranged diagonally along the length 112 and the width 114 of the bale wrap 58′, and one bale identifier 84′ is laterally and longitudinally offset from the other four bale identifiers 84′.

Furthermore, the cluster of five patterns repeats along the length 112 of the bale wrap 58′. Accordingly, the bale wrap 58′ includes five patterns that are each different than an adjacent pattern, such that each bale identifier 84′ of the set of bale identifiers of the pattern does not overlap any bale identifier of the set of bale identifiers of the adjacent pattern while the section 86′ of the bale wrap 58′ having the pattern and the adjacent pattern may be wrapped around the bale having the minimum bale circumference. While each pattern includes five bale identifiers 84′ in the illustrated embodiment, in other embodiments, at least one pattern may include more or fewer bale identifiers (e.g., 2, 3, 4, 6, 7, 8, or more).

While disposing the bale wrap section 86′ about the bale having the minimum bale circumference is disclosed above, the bale wrap section 86′ may also be disposed about a bale having a circumference greater than the minimum bale circumference and less than or equal to a maximum bale circumference. For example, in certain embodiments, the maximum bale circumference may be 25.12 feet (e.g., 7.66 m), which is the circumference of a bale having a maximum bale diameter of 8 feet (e.g., 2.44 m). In the illustrated embodiment, due to the patterns of bale identifiers 84′, each bale identifier of the set of bale identifiers of each pattern does not overlap any bale identifier of the set of bale identifiers of any other pattern while the section 86′ of the bale wrap 58′ is wrapped around a bale having a circumference between the minimum bale circumference (e.g., 12.56 feet) and the maximum bale circumference (e.g., 25.12 feet), inclusive of the minimum bale circumference and the maximum bale circumference. However, in other embodiments, at least one bale identifier of the set of bale identifiers of one pattern may overlap a bale identifier of the set of bale identifiers of another pattern while the section of the bale wrap is wrapped around a bale having a circumference greater than the minimum bale circumference.

In certain embodiments, the bale identifiers 84′ of each set include data indicative of a common bale code. For a bale having the minimum bale circumference, one or two sets of bale identifiers are positioned on the exterior of the wrapped bale. In addition, as previously discussed, in certain embodiments, the controller of the bale identification system associates the bale with a preceding bale code and with a succeeding bale code, in addition to the bale code corresponding to the scanned bale identifier. The preceding bale code corresponds to a preceding bale identifier (e.g., bale identifier of a preceding set of bale identifiers), and the succeeding bale code corresponds to a succeeding bale identifier (e.g., bale identifier of a succeeding set of bale identifiers).

Accordingly, if bale identifiers of one set, including the scanned bale identifier, and bale identifiers of the preceding set are positioned on the exterior of the wrapped bale, the bale may be identified by scanning a bale identifier of the one set or a bale identifier of the preceding set during subsequent bale identification (e.g., by the remote system). In addition, if bale identifiers of one set, including the scanned bale identifier, and bale identifiers of the succeeding set are positioned on the exterior of the wrapped bale, the bale may be identified by scanning a bale identifier of the one set or a bale identifier of the succeeding set during subsequent bale identification (e.g., by the remote system). While bale identifiers including data indicative of a common bale code for each set is disclosed above, in certain embodiments, the bale identifiers 84′ of each set may include data indicative of different bale codes.

In the illustrated embodiment, the bale wrap 58′ includes multiple numerical identifiers 118 disposed on or within the bale wrap substrate 82′. The numerical identifiers 118 are spaced apart from one another along the length 112 of the bale wrap 58′, and the numerical identifiers 118 indicate an amount of the bale wrap 58′ remaining. For example, in certain embodiments, the numerical identifiers 118 may be spaced apart at one foot intervals, thereby enabling an operator or an automated system to determine the number of feet of bale wrap remaining for the bale wrapping process.

Furthermore, in certain embodiments, the numerical identifiers 118 may be spaced apart by one minimum bale circumference C_{M}, thereby enabling an operator or an automated system to determine the number of portions of bale wrap remaining for the bale wrapping process. While one numerical identifier 118 is positioned at each location along the length 112 of the bale wrap 58′ in the illustrated embodiment, in other embodiments, multiple numerical identifiers may be positioned at each location along the length of the bale wrap (e.g., distributed along the width of the bale wrap). Furthermore, while the bale wrap 58′ includes the numerical identifiers 118 in the illustrated embodiment, in other embodiments, the numerical identifiers may be omitted.

In addition, in certain embodiments, the bale wrap may include other suitable identifier(s), such as one or more arrows indicating the direction of movement of the bale wrap (e.g., one or more arrows positioned proximate to each numerical identifier), a marketing or brand identifier (e.g., one marketing or brand identifier positioned proximate to each numerical identifier), etc. Furthermore, in certain embodiments, the bale wrap 58 disclosed above with reference to FIG. 4 may include numerical identifiers disposed on or within the bale wrap substrate 82 and having the features and variations of the numerical identifiers 118 disclosed above.

FIG. 6 is a schematic view of another embodiment of a section 86″ of a bale wrap 58″ that may be disposed about a bale in which the bale wrap 58″ includes bale identifiers 84″ that may be scanned by the bale identification system of FIG. 3. As previously discussed, the bale wrap 58″ includes a bale wrap substrate 82″, and the bale identifiers 84″ are disposed on or within the bale wrap substrate 82″. As illustrated, the bale identifiers 84″ are arranged in multiple patterns, each pattern includes two or more bale identifiers 84″, each pattern extends along the length 112 of the bale wrap 58″ equal to the minimum bale circumference C_{M}, and the patterns do not overlap one another along the length 112 of the bale wrap 58″. In the illustrated embodiment, each pattern may be different than an adjacent pattern, such that each bale identifier 84″ of the set of bale identifiers of the pattern does not overlap any bale identifier of the set of bale identifiers of the adjacent pattern while the section 86″ of the bale wrap 58″ having the pattern and the adjacent pattern is wrapped around a bale having the minimum bale circumference. Accordingly, in embodiments in which the bale wrap substrate is not completely opaque, the possibility of a bale identifier of an inner layer of the bale wrap section 86″ interfering with scanning of a bale identifier on the outer layer of the bale wrap section 86″ is substantially reduced or eliminated, thereby facilitating identification of the bale.

In the illustrated embodiment, the bale wrap 58″ is continuous. Accordingly, each end of the bale wrap section 86″ may be cut along any portion of a respective pattern. Furthermore, the patterns include a number of different patterns equal to a maximum number of layers of bale wrap 58″ around the bale having the minimum bale circumference. In the illustrated embodiment, the bale wrap 58″ has five different patterns because each section 86″ of the bale wrap 58″ wraps around the bale having the minimum bale circumference five times. However, in other embodiments (e.g., in embodiments in which the bale wrap section wraps around the bale having the minimum bale circumference more or fewer times), the bale wrap may have more or fewer patterns. For example, if each bale wrap section wraps around the bale having the minimum bale circumference four times, the bale wrap may have four different patterns, and if each bale wrap section wraps around the bale having the minimum bale circumference six times, the bale wrap may have six different patterns. Furthermore, in certain embodiments, each bale wrap section may include more or fewer patterns than the number of times the bale wrap section wraps around the bale having the minimum bale circumference. In the illustrated embodiment, the bale identifiers 84″ (e.g., the set of bale identifiers 84″) of each pattern are arranged linearly along the length 112 of the bale wrap 58″, and the patterns of the five pattern cluster are offset from one another along the width 114 of the bale wrap 58″. However, in other embodiments, the bale identifiers of each pattern may be arranged in another suitable configuration.

In the illustrated embodiment, the bale identifiers 84″ of a first set are arranged in a first pattern on a first portion 102″ of the bale wrap section 86″. As illustrated, the first set includes five bale identifiers 84″ arranged linearly along the length 112 of the bale wrap 58″. Furthermore, the bale identifiers 84″ of a second set are arranged in a second pattern on a second portion 104″ of the bale wrap section 86″. As illustrated, the second set also includes five bale identifiers 84″ arranged linearly along the length 112 of the bale wrap 58″, and the second pattern is offset from the first pattern along the width 114 of the bale wrap 58″.

In addition, the bale identifiers 84″ of a third set are arranged in a third pattern on a third portion 106″ of the bale wrap section 86″. As illustrated, the third set also includes five bale identifiers 84″ arranged linearly along the length 112 of the bale wrap 58″, and the third pattern is offset from the second pattern along the width 114 of the bale wrap 58″. Furthermore, the bale identifiers 84″ of a fourth set are arranged in a fourth pattern on a fourth portion 108″ of the bale wrap section 86″. As illustrated, the fourth set also includes five bale identifiers 84″ arranged linearly along the length 112 of the bale wrap 58″, and the fourth pattern is offset from the third pattern along the width 114 of the bale wrap 58″.

In addition, the bale identifiers 84″ of a fifth set are arranged in a fifth pattern on a fifth portion 116″ of the bale wrap section 86″. As illustrated, the fifth set also includes five bale identifiers 84″ arranged linearly along the length 112 of the bale wrap 58″, and the fifth pattern is offset from the fourth pattern along the width 114 of the bale wrap 58″. Furthermore, the cluster of five patterns repeats along the length 112 of the bale wrap 58″.

Accordingly, the bale wrap 58″ includes five patterns that are each different than an adjacent pattern, such that each bale identifier 84″ of the set of bale identifiers of the pattern does not overlap any bale identifier of the set of bale identifiers of the adjacent pattern while the section 86″ of the bale wrap 58″ having the pattern and the adjacent pattern is wrapped around the bale having the minimum bale circumference. While each pattern includes five bale identifiers 84″ in the illustrated embodiment, in other embodiments, at least one pattern may include more or fewer bale identifiers (e.g., 2, 3, 4, 6, 7, 8, or more).

While disposing the bale wrap section 86″ about the bale having the minimum bale circumference is disclosed above, the bale wrap section 86″ may also be disposed about a bale having a circumference greater than the minimum bale circumference and less than or equal to a maximum bale circumference. For example, in certain embodiments, the maximum bale circumference may be 25.12 feet (e.g., 7.66 m), which is the circumference of a bale having a maximum bale diameter of 8 feet (e.g., 2.44 m). In the illustrated embodiment, due to the patterns of bale identifiers 84″, each bale identifier of the set of bale identifiers of each pattern does not overlap any bale identifier of the set of bale identifiers of any other pattern while the section 86″ of the bale wrap 58″ may be wrapped around a bale having a circumference between the minimum bale circumference (e.g., 12.56 feet) and the maximum bale circumference (e.g., 25.12 feet), inclusive of the minimum bale circumference and the maximum bale circumference. However, in other embodiments, at least one bale identifier of the set of bale identifiers of one pattern may overlap a bale identifier of the set of bale identifiers of another pattern while the section of the bale wrap may be wrapped around a bale having a circumference greater than the minimum bale circumference.

In certain embodiments, the bale identifiers 84″ of each set include data indicative of a common bale code. For a bale having the minimum bale circumference, one or two sets of bale identifiers are positioned on the exterior of the wrapped bale. In addition, as previously discussed, in certain embodiments, the controller of the bale identification system associates the bale with a preceding bale code and with a succeeding bale code, in addition to the bale code corresponding to the scanned bale identifier. The preceding bale code corresponds to a preceding bale identifier (e.g., bale identifier of a preceding set of bale identifiers), and the succeeding bale code corresponds to a succeeding bale identifier (e.g., bale identifier of a succeeding set of bale identifiers).

Accordingly, if bale identifiers of one set, including the scanned bale identifier, and bale identifiers of the preceding set are positioned on the exterior of the wrapped bale, the bale may be identified by scanning a bale identifier of the one set or a bale identifier of the preceding set during subsequent bale identification (e.g., by the remote system). In addition, if bale identifiers of one set, including the scanned bale identifier, and bale identifiers of the succeeding set are positioned on the exterior of the wrapped bale, the bale may be identified by scanning a bale identifier of the one set or a bale identifier of the succeeding set during subsequent bale identification (e.g., by the remote system). While bale identifiers including data indicative of a common bale code for each set is disclosed above, in certain embodiments, the bale identifiers 84″ of each set may include data indicative of different bale codes.

In the illustrated embodiment, the bale wrap 58″ includes multiple numerical identifiers 118′ disposed on or within the bale wrap substrate 82″. The numerical identifiers 118′ are spaced apart from one another along the length 112 of the bale wrap 58″, and the numerical identifiers 118′ indicate an amount of the bale wrap 58″ remaining. For example, in certain embodiments, the numerical identifiers 118′ may be spaced apart at one foot intervals, thereby enabling an operator or an automated system to determine the number of feet of bale wrap remaining for the bale wrapping process. Furthermore, in certain embodiments, the numerical identifiers 118′ may be spaced apart by one minimum bale circumference C_{M}, thereby enabling an operator or an automated system to determine the number of portions of bale wrap remaining for the bale wrapping process. While one numerical identifier 118′ is positioned at each location along the length 112 of the bale wrap 58″ in the illustrated embodiment, in other embodiments, multiple numerical identifiers may be positioned at each location along the length of the bale wrap (e.g., distributed along the width of the bale wrap). Furthermore, while the bale wrap 58″ includes the numerical identifiers 118′ in the illustrated embodiment, in other embodiments, the numerical identifiers may be omitted. In addition, in certain embodiments, the bale wrap may include other suitable identifier(s), such as one or more arrows indicating the direction of movement of the bale wrap (e.g., one or more arrows positioned proximate to each numerical identifier), a marketing or brand identifier (e.g., one marketing or brand identifier positioned proximate to each numerical identifier), etc.

While two repeating clusters of patterns are disclosed above with reference to FIGS. 5-6, the bale wrap may have another suitable repeating cluster of patterns, in which each pattern is different than an adjacent pattern, such that each bale identifier of the set of bale identifiers of the pattern does not overlap any bale identifier of the set of bale identifiers of the adjacent pattern while a section of the bale wrap having the pattern and the adjacent pattern is wrapped around a bale having the minimum bale circumference. Furthermore, in certain embodiments, the bale wrap may have a non-repeating cluster of patterns, such that a single cluster of patterns extends along an entire length of the bale wrap (e.g., such that each pattern is different than every other pattern). In addition, in certain embodiments, the bale wrap 58 disclosed above with reference to FIG. 4 may have any arrangement of bale identifiers disclosed above with reference to FIGS. 5-6. Furthermore, in certain embodiments, the bale wrap 58 disclosed above with reference to FIG. 4 may have another suitable arrangement of bale identifiers (e.g., an arrangement in which at least one bale identifier of the set of bale identifiers of one pattern overlaps a bale identifier of the set of bale identifiers of an adjacent pattern while a section of the bale wrap having the pattern and the adjacent pattern is wrapped around a bale having the minimum bale circumference).

Furthermore, in embodiments in which the bale wrap is continuous, such as the embodiments disclosed above with reference to FIGS. 4-6, a bale identifier or a numerical identifier may function as a cut location indicator. As previously discussed, in certain embodiments, the bale wrapping system identifies a cut location indicator of the bale wrap to locate an interface between an end of a first section and a beginning of a second section. In response to determining the interface is positioned at a cutting system, the bale wrapping system controls the cutting system to separate the first section, which is disposed about the bale, from the second section, which is disposed about the shaft/center hollow region of the bale wrap assembly. In certain embodiments, particular numerical indicators may function as cut location indicators. In such embodiments, the bale wrapping system may locate each interface by identifying a respective numerical indicator (e.g., via a scanner). Furthermore, in certain embodiments, particular bale identifiers may function as cut location indicators. In such embodiments, the bale wrapping system may locate each interface by identifying a respective bale identifier (e.g., via a scanner).

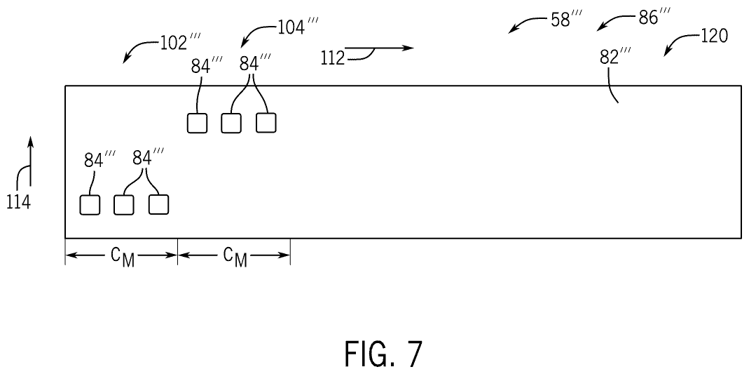

FIG. 7 is a schematic view of a further embodiment of a section 86″′ of a bale wrap 58″′ that may be disposed about a bale, in which the bale wrap 58″′ includes bale identifiers 84″′ that may be scanned by the bale identification system of FIG. 3. As previously discussed, the bale wrap 58″′ includes a bale wrap substrate 82″′, and the bale identifiers 84″′ are disposed on or within the bale wrap substrate 82″′. As illustrated, the bale identifiers 84″′ are arranged in multiple patterns, each pattern includes two or more bale identifiers 84″′, each pattern extends along the length 112 of the bale wrap 58″′ equal to the minimum bale circumference C_{M}, and the patterns do not overlap one another along the length 112 of the bale wrap 58″′. In the illustrated embodiment, each pattern is different than the adjacent pattern, such that each bale identifier 84″′ of the set of bale identifiers of the pattern does not overlap any bale identifier of the set of bale identifiers of the adjacent pattern while the section 86″′ of the bale wrap 58″′ having the pattern and the adjacent pattern is wrapped around a bale having the minimum bale circumference. Accordingly, in embodiments in which the bale wrap substrate is not completely opaque, the possibility of a bale identifier of an inner layer of the bale wrap section 86″′ interfering with scanning of the bale identifier on the outer layer of the bale wrap section 86″′ is substantially reduced or eliminated, thereby facilitating identification of the bale.

In the illustrated embodiment, the bale wrap 58″′ is segmented into multiple segments 120, in which each segment corresponds to a respective section 86″′. Each segment 120 has a first pattern of bale identifiers 84″′ positioned at an end (e.g., longitudinal end) of the segment 120 and a second pattern of bale identifiers 84″′ positioned adjacent to the first pattern (e.g., along the length 112 of the bale wrap 58″′). In the illustrated embodiment, the bale identifiers 84″′ of a first set are arranged in a first pattern on a first portion 102″′ of the bale wrap section 86″′/segment 120. As illustrated, the first set includes three bale identifiers 84″′ arranged linearly along the length 112 of the bale wrap 58″′. Furthermore, the bale identifiers 84″′ of a second set are arranged in a second pattern on a second portion 104″′ of the bale wrap section 86″′/segment 120.

As illustrated, the second set also includes three bale identifiers 84″′ arranged linearly along the length 112 of the bale wrap 58″′, and the second pattern is offset from the first pattern along the width 114 of the bale wrap 58″′. Accordingly, the bale wrap 58″′ includes two patterns that are each different than the adjacent pattern (e.g., the two patterns are different than one another), such that each bale identifier 84″′ of the set of bale identifiers of the pattern (e.g., the first pattern) does not overlap any bale identifier of the set of bale identifiers of the adjacent pattern (e.g., the second pattern) while the section 86″′/segment 120 of the bale wrap 58″′ having the pattern and the adjacent pattern is wrapped around the bale having the minimum bale circumference. While each pattern includes three bale identifiers 84″′ in the illustrated embodiment, in other embodiments, at least one pattern may include more or fewer bale identifiers (e.g., 2, 4, 5, 6, 7, 8, or more).

Furthermore, while each set of bale identifiers 84″′ are arranged linearly along the length 112 of the bale wrap 58″′ in the illustrated embodiment, in other embodiments, the bale wrap may include other suitable patterns, in which each pattern is different than an adjacent pattern, such that each bale identifier of the set of bale identifiers of the pattern (e.g., the first pattern) does not overlap any bale identifier of the set of bale identifiers of the adjacent pattern (e.g., the second pattern) while a section/segment of the bale wrap having the pattern and the adjacent pattern is wrapped around a bale having the minimum bale circumference.

While disposing the bale wrap section 86″′/segment 120 about the bale having the minimum bale circumference is disclosed above, the bale wrap section 86″′/segment 120 may also be disposed about a bale having a circumference greater than the minimum bale circumference and less than or equal to a maximum bale circumference. For example, in certain embodiments, the maximum bale circumference may be 25.12 feet (e.g., 7.66 m), which is the circumference of a bale having a maximum bale diameter of 8 feet (e.g., 2.44 m). In the illustrated embodiment, due to the patterns of bale identifiers 84″′, each bale identifier of the set of bale identifiers of each pattern does not overlap any bale identifier of the set of bale identifiers of the other pattern while the section 86″′/segment of the bale wrap 58″′ is wrapped around a bale having a circumference between the minimum bale circumference (e.g., 12.56 feet) and the maximum bale circumference (e.g., 25.12 feet), inclusive of the minimum bale circumference and the maximum bale circumference.

In certain embodiments, the bale wrap may include multiple numerical identifiers disposed on or within the bale wrap substrate. In such embodiments, the numerical identifiers are spaced apart from one another along the length of the bale wrap, and the numerical identifiers indicate an amount of the bale wrap remaining and/or an amount of the bale wrap segment remaining. For example, in certain embodiments, the numerical identifiers may be spaced apart at one-foot intervals, thereby enabling an operator or an automated system to determine the number of feet of the bale wrap and/or the bale wrap segment remaining for the bale wrapping process.

Furthermore, in certain embodiments, the numerical identifiers may be spaced apart by one minimum bale circumference C_{M}, thereby enabling an operator or an automated system to determine the number of portions of the bale wrap and/or the bale wrap segment remaining for the bale wrapping process. For instance, in certain embodiments, one numerical identifier may be positioned at each location along the length of the bale wrap, and in other embodiments, multiple numerical identifiers may be positioned at each location along the length of the bale wrap (e.g., distributed along the width of the bale wrap). Furthermore, in other certain embodiments, the bale wrap may include other suitable identifier(s), such as one or more arrows indicating the direction of movement of the bale wrap (e.g., one or more arrows positioned proximate to each numerical identifier), a marketing or brand identifier (e.g., one marketing or brand identifier positioned proximate to each numerical identifier), etc.

In the embodiments disclosed above, the bale identifiers may be positioned on the outer circumferential surface of the wrapped bale, thereby enabling scanner(s) directed toward the outer circumferential surface of the wrapped bale to scan the bale identifiers. However, in certain embodiments, one or more bale identifiers may be positioned on at least one longitudinal end of the wrapped bale. For example, in certain embodiments, the bale wrap section has a width greater than the width of the bale, thereby enabling the bale wrap section to form shoulders on the longitudinal ends of the bale while disposed about the bale. One or more bale identifiers may be positioned on the shoulders. In certain embodiments, the bale identifier(s) positioned on the shoulders at a respective portion of the bale wrap section may include data indicative of the same bale code as the set of bale identifiers positioned at the respective portion. Furthermore, in certain embodiments, bale identifiers positioned on the shoulders may be spaced apart from one another to substantially reduce or eliminate the possibility of one bale identifier on a shoulder overlapping another bale identifier on the shoulder.

While a minimum bale diameter of four feet and a maximum bale diameter of eight feet are disclosed above, in certain embodiments, the minimum bale diameter may be greater or less than four feet, and/or the maximum bale diameter maybe greater or less than eight feet. For example, in certain embodiments, the minimum bale diameter may be three feet, five feet, six feet, or more. In addition, in certain embodiments, the maximum bale diameter may be 7 feet, 9 feet, 10 feet, or more.

While scanning bale identifier(s) of a wrapped bale while the wrapped bale is in the field (e.g., after the wrapped bale is discharged from the bale handler system) is disclosed above, in certain embodiments, the bale identifiers of the bale wraps of FIGS. 5-7 may be scanned during the baling process (e.g., during the bale wrapping process) or while the wrapped bale is on the bale handler. For example, in certain embodiments, a bale identification system may include a scanner directed toward an internal region of the agricultural harvester (e.g., a region within the baler, a region within the bale handler, etc.), in which the scanner scans a bale identifier of a bale wrap and outputs a signal indicative of a respective bale code corresponding to the bale identifier. The bale identification system may also include a controller communicatively coupled to the scanner, in which the controller includes a processor and a memory. The controller receives the signal indicative of the respective bale code, and the controller associates the bale with the respective bale code and, in certain embodiments, the preceding bale code and the succeeding bale code. As previously discussed, the preceding bale code corresponds to a preceding bale identifier, and the succeeding bale code corresponds to a succeeding bale identifier.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical.

1. A bale wrap comprising:
a bale wrap substrate; and
a plurality of bale identifiers disposed on or within the bale wrap substrate;
wherein the plurality of bale identifiers are arranged in a plurality of patterns; and
wherein each pattern of the plurality of patterns comprises being:
formable by a set of two or more bale identifiers of the plurality of bale identifiers;
extendable along a length of the bale wrap equal to a minimum bale circumference; and
different than an adjacent pattern of the plurality of patterns.

2. The bale wrap of claim 1, wherein the bale wrap is segmented into a plurality of segments, each segment of the plurality of segments has a first pattern of the plurality of patterns positioned at an end of the segment and a second pattern of the plurality of patterns positioned adjacent to the first pattern.

3. The bale wrap of claim 1, wherein the bale wrap is continuous;
wherein the plurality of patterns comprises a number of different patterns equal to a maximum number of layers of the bale wrap around the bale having the minimum bale circumference; and
wherein the plurality of patterns do not overlap one another along the length of the bale wrap.

4. The bale wrap of claim 3, wherein the set of two or more bale identifiers of each pattern of the plurality of patterns are arranged linearly along the length of the bale wrap; or
wherein the set of two or more bale identifiers of each pattern of the plurality of patterns are distributed along the length of the bale wrap and along a width of the bale wrap.

5. The bale wrap of claim 1, wherein the being different than the adjacent pattern of the plurality of patterns comprises each bale identifier of the set of two or more bale identifiers of the pattern not overlapping with any bale identifier of the set of two or more bale identifiers of the adjacent pattern while a section of the bale wrap having the pattern and the adjacent pattern is wrapped around a bale having the minimum bale circumference.

6. The bale wrap of claim 1, wherein the bale identifiers of each set of two or more bale identifiers comprise data indicative of a common bale code.

7. The bale wrap of claim 1, comprising a plurality of numerical identifiers disposed on or within the bale wrap substrate, wherein the plurality of numerical identifiers are spaced apart from one another along the length of the bale wrap, and the plurality of numerical identifiers indicate an amount of the bale wrap remaining.

8. A bale wrap comprising:
a bale wrap substrate; and
a plurality of bale identifiers disposed on or within the bale wrap substrate;
wherein the plurality of bale identifiers are arranged in a plurality of patterns that do not overlap; and
wherein each pattern of the plurality of patterns is formable by a set of two or more bale identifiers of the plurality of bale identifiers and extendable along a length of the bale wrap equal to a minimum bale circumference.

9. The bale wrap of claim 8, further comprising a plurality of numerical identifiers disposed on or within the bale wrap substrate, wherein the plurality of numerical identifiers are spaced apart from one another along the length of the bale wrap, and the plurality of numerical identifiers indicate an amount of bale wrap remaining; and
wherein the bale identifiers of each set of two or more bale identifiers comprise data indicative of a common bale code.

10. A bale identification system for an agricultural harvester, comprising:
a scanner directed to a region external to the agricultural harvester, wherein the scanner scans a bale identifier of a plurality of bale identifiers of a bale wrap while a section of the bale wrap including the bale identifier is disposed about a bale in a field, the scanner outputs a signal indicative of a respective bale code of a plurality of bale codes, and the respective bale code corresponds to the bale identifier; and
a controller communicatively coupled to the scanner, wherein the controller comprises a processor and a memory, and the controller:
receives the signal indicative of the respective bale code; and
associates the bale with the respective bale code.

11. The bale identification system of claim 10, wherein the controller associates the bale with a preceding bale code of the plurality of bale codes and with a succeeding bale code of the plurality of bale codes, the preceding bale code corresponds to a preceding bale identifier of the plurality of bale identifiers, and the succeeding bale code corresponds to a succeeding bale identifier of the plurality of bale identifiers.

12. The bale identification system of claim 10, comprising the bale wrap, wherein the bale wrap comprises:
a bale wrap substrate; and
the plurality of bale identifiers disposed on or within the bale wrap substrate, wherein the plurality of bale identifiers are arranged in a plurality of patterns, each pattern of the plurality of patterns is formed by a set of two or more bale identifiers of the plurality of bale identifiers, each pattern of the plurality of patterns extends along a length of the bale wrap equal to a minimum bale circumference, and the plurality of patterns do not overlap one another.

13. The bale identification system of claim 12, wherein the bale identifiers of each set of two or more bale identifiers comprise data indicative of a common bale code of the plurality of bale codes.

14. The bale identification system of claim 13, wherein the controller associates the bale with a preceding bale code of the plurality of bale codes and with a succeeding bale code of the plurality of bale codes, the preceding bale code corresponds to a preceding bale identifier of the plurality of bale identifiers, and the succeeding bale code corresponds to a succeeding bale identifier of the plurality of bale identifiers.

15. The bale identification system of claim 12, wherein the bale wrap comprises a plurality of numerical identifiers disposed on or within the bale wrap substrate, the plurality of numerical identifiers are spaced apart from one another along the length of the bale wrap, and the plurality of numerical identifiers indicate an amount of bale wrap remaining.

16. The bale identification system of claim 12, wherein each pattern of the plurality of patterns is different than an adjacent pattern of the plurality of patterns such that each bale identifier of the set of bale identifiers of the pattern does not overlap any bale identifier of the set of bale identifiers of the adjacent pattern while a representative section of the bale wrap having the pattern and the adjacent pattern is wrapped around a representative bale having the minimum bale circumference.

17. The bale identification system of claim 16, wherein the bale wrap is segmented into a plurality of segments, each segment of the plurality of segments has a first pattern of the plurality of patterns positioned at an end of the segment and a second pattern of the plurality of patterns positioned adjacent to the first pattern.

18. The bale identification system of claim 16, wherein the bale wrap is continuous, and the plurality of patterns comprises a number of different patterns equal to a maximum number of layers of the bale wrap around the representative bale having the minimum bale circumference.

19. The bale identification system of claim 18, wherein the set of bale identifiers of each pattern of the plurality of patterns are arranged linearly along the length of the bale wrap.

20. The bale identification system of claim 18, wherein the set of bale identifiers of each pattern of the plurality of patterns are distributed along the length of the bale wrap and along a width of the bale wrap.
